(19) United States
(12) Patent Application Publication
(10) Pub. No.: US 2014/0329564 A1
(43) Pub. Date: Nov. 6, 2014

(54) USER INTERFACE APPARATUS AND ASSOCIATED METHODS

(71) Applicant: NOKIA CORPORATION, Espoo (FI)

(72) Inventors: Sami Ronkainen, Tampere (FI); Urho Konttorri, Helsinki (FI); Martin Jansky, Espoo (FI); Daniel Gratiot, London (GB)

(73) Assignee: Nokia Corporation, Espoo (FI)

(21) Appl. No.: 13/875,813

(22) Filed: May 2, 2013

(51) Int. Cl. H04M 1/725

(52) U.S. Cl. CPC H04M 1/72563
USPC 455/566

(57) ABSTRACT

An apparatus comprising:
at least one processor; and
at least one memory including computer program code,
the at least one memory and the computer program code configured to, with the at least one processor, cause the apparatus to perform at least the following:
enable selection of a particular function of an electronic device based on a comparison between received shape data corresponding to at least one object within a detection range of a user interface of the electronic device and predefined ear shape data.

### TECHNICAL FIELD

The present disclosure relates to the field of user interfaces configured to enable functionality based on volume determinations, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs), mobile telephones, smartphones and other smart devices, and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

It is common for electronic devices to provide a user interface (e.g. a graphical user interface). A user interface may enable a user to interact with an electronic device, for example, to enter commands, or to receive information from the device (e.g. visual or audio content).

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect there is provided an apparatus comprising:
at least one processor; and
at least one memory including computer program code,
the at least one memory and the computer program code configured to, with the at least one processor, cause the apparatus to perform at least the following:
enable selection of a particular function of an electronic device based on a comparison between received shape data corresponding to at least one object within a detection range of a user interface of the electronic device and predefined ear shape data.

The received shape data and/or predefined ear shape data may comprise one or more of:
an image of the at least one object;
a 3D topology of the at least one object;
a tomogram of the at least one object (e.g. a cross-section obtained by tomography); and
a 2D print of the object.

The ear shape data may comprise data corresponding to the shape of at least a portion of an ear and/or at least a portion of a head.

The detection range may, for example, up to 5 cm above and/or up to 1 cm outside the (outer) surface of the user interface (e.g. a touch screen or touchpad user interface).

The particular function may comprise enabling a particular device operating mode of a plurality of device operating modes associated with the electronic device. A said device operating mode may be a handset mode, a parent mode, a child mode, an adult mode, a user-defined device operating mode, or a user-specific device operating mode.

The particular function may comprise enabling a particular application operating mode of a plurality of application operating modes associated with the electronic device. A said application operating mode may be a parent mode, a text to speech mode, an audio mode, a child mode (e.g. wherein a web browsing application restricts/prevents the presentation of adult content), an adult mode, a user-defined application operating mode, or a user-specific application operating mode.

The particular function may comprise one or more of:
answering an incoming call;
activating speech synthesis of textual content (e.g. received text message, calendar alert, email); and
activating a handset mode.

The particular function may or may not comprise providing audio content to the user.

The selection of the particular function may also be based on a comparison between received motion data corresponding to the motion of the electronic device and predefined gesture data.

The motion data may comprise data relating to one or more of:
velocity of a said electronic device;
distance travelled by said electronic device;
the trajectory of a said electronic device;
speed of a said electronic device; and
acceleration of a said electronic device.

The selection of the particular function may also be based on a comparison between received colour data corresponding to the at least one object within the detection range of the user interface of the electronic device and predefined colour data. The colour data may relate to skin colour and/or hair colour.

The received shape data may be detected by at least one of:
a capacitive sensor;
a resistance sensor;
an electromagnetic radiation sensor;
a touch sensor;
a temperature sensor;
a camera; and
an infrared sensor.

The predefined ear shape data may be associated with a particular user, the enabled function corresponding to the particular user.

The predefined ear data may be associated with an age category, the enabled function corresponding to the age category. For example, ear shape data corresponding with a small ear may be associated with a child age category and the enabled function may be specific to the child age category.

The received shape data may be configured to provide authentication information, the authentication information configured to enable the device to authenticate a particular user such that the particular user is allowed to access particular functions which are specific to the particular user.

The predefined ear data may be recorded by the apparatus when a user holds their ear within the detection range of a user interface of the electronic device.

The apparatus may be configured to:
enable termination of the particular function of an electronic device when the received data within the detection range of a user interface of the electronic device is inconsistent with the predefined ear shape data.

The user interface may comprise a combination of one or more of a speaker, a microphone, a handset, a headset, a touchpad (e.g. a touch and/or hover sensor configured not to provide visual content to the user), and a touch-screen (e.g. a touch and/or hover sensor configured to provide visual content to the user).

The electronic device or apparatus may be a portable electronic device, a laptop computer, a desktop computer, a mobile phone, a Smartphone, a monitor, a tablet computer, a personal digital assistant or a digital camera, or a module for the same.

In a further aspect, there is provided a method comprising:
enabling selection of a particular function of an electronic device based on a comparison between received shape data corresponding to at least one object within a detection range of a user interface of the electronic device and predefined ear shape data.

In a further aspect, there is provided a computer program, the computer program comprising code configured to:
enable selection of a particular function of an electronic device based on a comparison between received shape data corresponding to at least one object within a detection range of a user interface of the electronic device and predefined ear shape data.

The computer program may be stored on a storage media (e.g. on a CD, a DVD, a memory stick or other non-transitory medium). The computer program may be configured to run on a device or apparatus as an application. An application may be run by a device or apparatus via an operating system.

In a further aspect, there is provided an apparatus, the apparatus comprising:
means for enabling selection of a particular function of an electronic device based on a comparison between received shape data corresponding to at least one object within a detection range of a user interface of the electronic device and predefined ear shape data.

In a further aspect, there is provided an apparatus, the apparatus comprising:
an enabler configured to enable selection of a particular function of an electronic device based on a comparison between received shape data corresponding to at least one object within a detection range of a user interface of the electronic device and predefined ear shape data.

The present disclosure includes one or more corresponding aspects, embodiments or features in isolation or in various combinations whether or not specifically stated (including claimed) in that combination or in isolation. Corresponding means and corresponding function units (e.g. first enabler, second enabler) for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 depicts an example embodiment comprising a number of electronic components, including memory and a processor.

FIG. 2 depicts an example embodiment comprising a number of electronic components, including memory, a processor and a communication unit.

FIG. 3 depicts an example embodiment comprising a number of electronic components, including memory, a processor and a communication unit.

FIGS. 4a-4f depict an example embodiment wherein a function is enabled based on a comparison of three dimensional topological shape data.

FIGS. 5a-5g depict a further example embodiment wherein a function is enabled based on a comparison of two dimensional shape data.

FIGS. 6a-6d depict an example embodiment wherein a function is enabled based on a comparison of image shape data.

FIGS. 7a-7b illustrate an example apparatus in communication with a remote server/cloud.

FIG. 8 illustrates a flowchart according to an example method of the present disclosure.

FIG. 9 illustrates schematically a computer readable medium providing a program.

### DESCRIPTION OF EXAMPLE ASPECTS/EMBODIMENTS

It is common for an electronic device to have a user interface (which may or may not be graphically based) to allow a user to interact with the device to provide, receive and/or interact with information. For example, the user may use their fingers to compose a text message, draw a picture or access a web site, and/or use their ear to listen to a phone call or music.

It may be advantageous to tailor the functionality of the device to the particular part of the body being used to interact with the device. For example, when using the ear, the device may be configured to provide audio content, and when using the eyes or fingers, the device may be configured to provide visual and/or tactile content.

Example embodiments contained herein may be considered to enable selection of a particular function of an electronic device based on a comparison between received shape data corresponding to at least one object within a detection range of a user interface of the electronic device and predefined ear shape data.

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of other similar described embodiments.

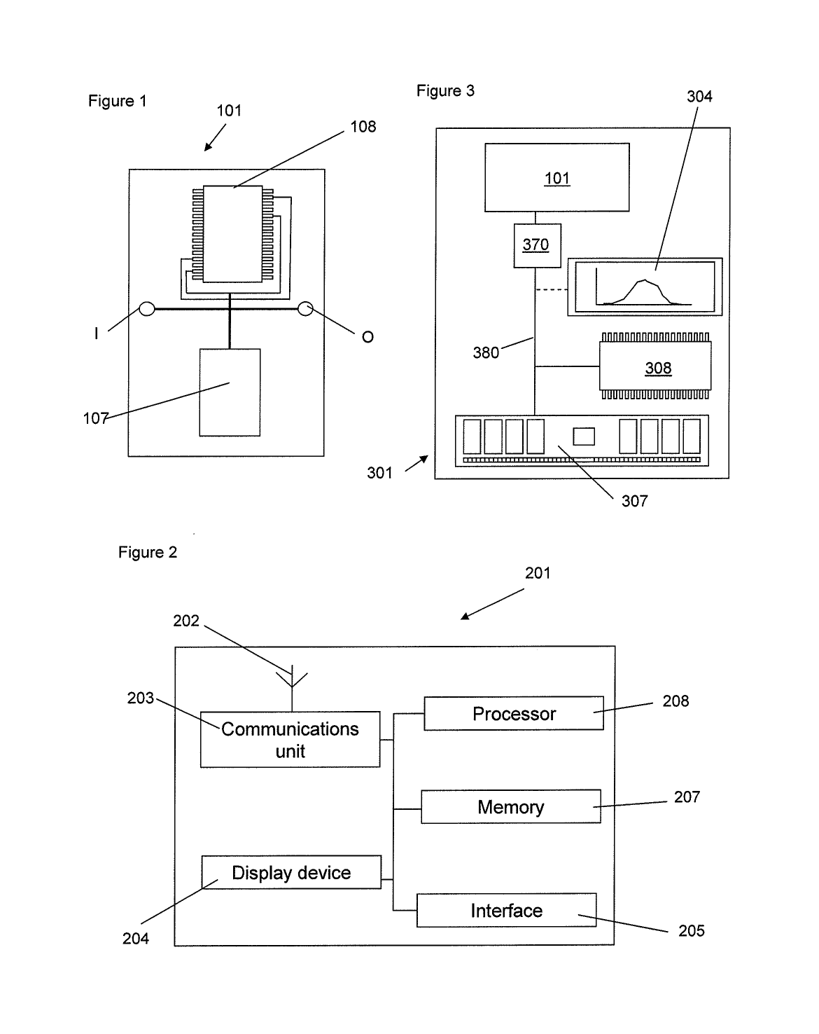

FIG. 1 shows an apparatus (101) comprising memory (107), a processor (108), input I and output O. In this embodiment only one processor and one memory are shown but it will be appreciated that other embodiments may utilise more than one processor and/or more than one memory (e.g. same or different processor/memory types).

In this embodiment the apparatus (101) is an Application Specific Integrated Circuit (ASIC) for a portable electronic device with a touch sensitive display. In other embodiments the apparatus (101) can be a module for such a device, or may be the device itself, wherein the processor (108) is a general purpose CPU of the device and the memory (107) is general purpose memory comprised by the device.

The input I allows for receipt of signalling to the apparatus (101) from further components, such as components of a portable electronic device (like a touch-sensitive display) or the like. The output O allows for onward provision of signalling from within the apparatus (101) to further components. In this embodiment the input I and output O are part of a connection bus that allows for connection of the apparatus (101) to further components.

The processor (108) is a general purpose processor dedicated to executing/processing information received via the input I in accordance with instructions stored in the form of computer program code on the memory (107). The output signalling generated by such operations from the processor (108) is provided onwards to further components via the output O.

The memory (107) (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor (108). The internal connections between the memory (107) and the processor (108) can be understood to, in one or more example embodiments, provide an active coupling between the processor (108) and the memory (107) to allow the processor (108) to access the computer program code stored on the memory (107).

In this example the input I, output O, processor (108) and memory (107) are all electrically connected to one another internally to allow for electrical communication between the respective components I, O, (108, 107). In this example the components are all located proximate to one another so as to be formed together as an ASIC, in other words, so as to be integrated together as a single chip/circuit that can be installed into an electronic device. In other examples one or more or all of the components may be located separately from one another.

FIG. 2 depicts an apparatus (201) of a further example embodiment, such as a mobile phone. In other example embodiments, the apparatus (201) may comprise a module for a mobile phone (or PDA or audio/video player), and may just comprise a suitably configured memory (207) and processor (208).

The example embodiment of FIG. 2, in this case, comprises a display device (204) such as, for example, a Liquid Crystal Display (LCD) or touch-screen user interface. The apparatus (201) of FIG. 2 is configured such that it may receive, include, and/or otherwise access data. For example, this example embodiment (201) comprises a communications unit (203), such as a receiver, transmitter, and/or transceiver, in communication with an antenna (202) for connecting to a wireless network and/or a port (not shown) for accepting a physical connection to a network, such that data may be received via one or more types of networks. This example embodiment comprises a memory (207) that stores data, possibly after being received via antenna (202) or port or after being generated at the user interface (205). The processor (208) may receive data from the user interface (205), from the memory (207), or from the communication unit (203). It will be appreciated that, in certain example embodiments, the display device (204) may incorporate the user interface (205). Regardless of the origin of the data, these data may be outputted to a user of apparatus (201) via the display device (204), and/or any other output devices provided with apparatus (e.g. speaker). The processor (208) may also store the data for later use in the memory (207). The memory (207) may store computer program code and/or applications which may be used to instruct/enable the processor (208) to perform functions (e.g. read, write, delete, edit or process data).

FIG. 3 depicts a further example embodiment of an electronic device (301), such as a tablet personal computer, a portable electronic device, a portable telecommunications device, a server or a module for such a device, the device comprising the apparatus (101) of FIG. 1. The apparatus (101) can be provided as a module for device (301), or even as a processor/memory for the device (301) or a processor/memory for a module for such a device (301). The device (301) comprises a processor (308) and a storage medium (307), which are connected (e.g. electrically and/or wirelessly) by a data bus (380). This data bus (380) can provide an active coupling between the processor (308) and the storage medium (307) to allow the processor (308) to access the computer program code. It will be appreciated that the components (e.g. memory, processor) of the device/apparatus may be linked via cloud computing architecture. For example, the storage device may be a remote server accessed via the internet by the processor.

The apparatus (101) in FIG. 3 is connected (e.g. electrically and/or wirelessly) to an input/output interface (370) that receives the output from the apparatus (101) and transmits this to the device (301) via data bus (380). Interface (370) can be connected via the data bus (380) to a display (304) (touch-sensitive or otherwise) that provides information from the apparatus (101) to a user. Display (304) can be part of the device (301) or can be separate. The device (301) also comprises a processor (308) configured for general control of the apparatus (101) as well as the device (301) by providing signalling to, and receiving signalling from, other device components to manage their operation.

The storage medium (307) is configured to store computer code configured to perform, control or enable the operation of the apparatus (101). The storage medium (307) may be configured to store settings for the other device components. The processor (308) may access the storage medium (307) to retrieve the component settings in order to manage the operation of the other device components. The storage medium (307) may be a temporary storage medium such as a volatile random access memory. The storage medium (307) may also be a permanent storage medium such as a hard disk drive, a flash memory, a remote server (such as cloud storage) or a non-volatile random access memory. The storage medium (307) could be composed of different combinations of the same or different memory types.

The aforementioned apparatus (101, 201, and 301) are configured to enable the comparison of shape data and accordingly enable the selection of a particular function as previously mentioned.

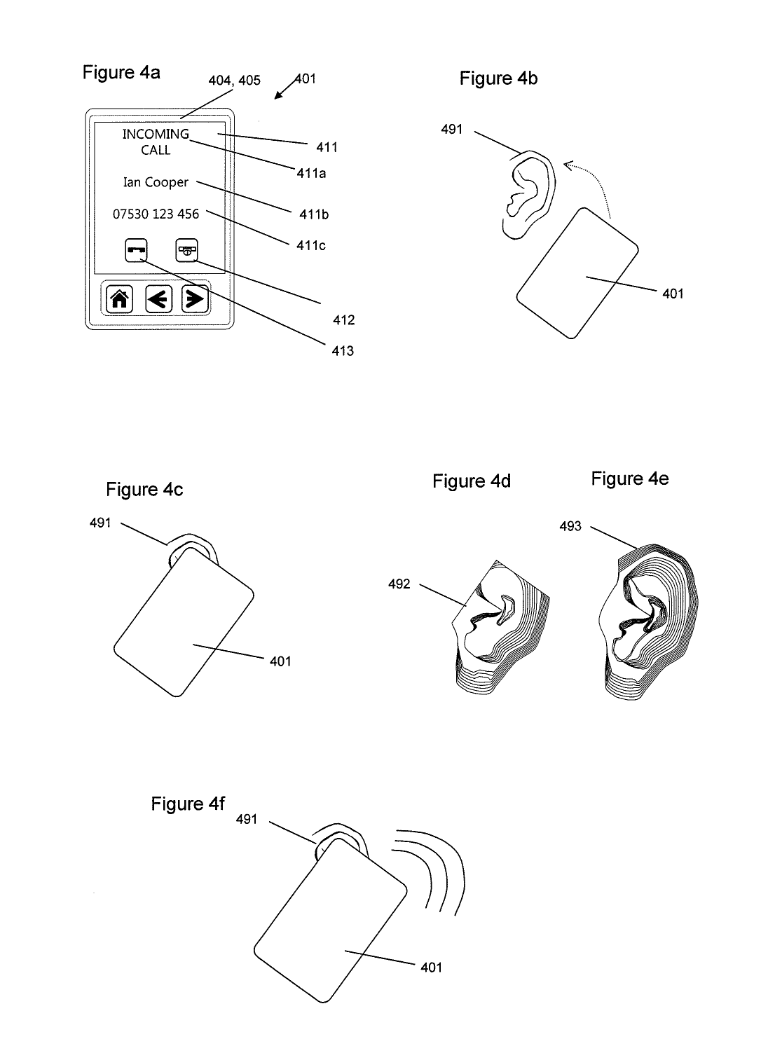

FIGS. 4a-4f depicts an example embodiment of the apparatus depicted in FIG. 2 comprising a portable electronic communications device (401), e.g. such as a mobile phone, with a user interface comprising a capacitive touch-screen user interface (405, 404), a memory (not shown), a processor (not shown) and an antenna (not shown) for transmitting and/or receiving data (e.g. emails, textual messages, phone calls, information corresponding to web pages). The capacitive touch screen user interface, in this case, is configured to detect objects within a detection range (e.g. within 5 cm of the touch screen).

In this case, the apparatus is configured to: enable selection of a particular function of an electronic device based on a comparison between received shape data corresponding to at least one object within a detection range of a user interface of the electronic device and predefined ear shape data. In this case, if the comparison indicates that the received shape data is consistent with the predefined ear shape data (thereby indicating that an ear is within the detection range of the user interface), the apparatus is configured to enable the function of answering an incoming call.

In the situation depicted in FIG. 4a, the device (401) is alerting the user to an incoming call. When an incoming call alert is ongoing, the screen is configured to provide an incoming call indication (411). In this case, the incoming call indication provides textual information (411a-411c) including the name of the person initiating the call (411b) and their number (411c). It will be appreciated that the phone may also ring, to provide an audio incoming call indication (e.g. if the phone is not in a ‘silent’ mode) and/or provide a tactile indication (e.g. by vibrating). In addition to providing an incoming call indication (411), the apparatus/device is configured to provide an answer call user interface element (412), configured to allow the user to accept the incoming call; and a reject call user interface element (413) configured to allow the user to reject the call.

However, in this case, the device is configured to allow the user to accept the call by putting the phone to their ear, such that at least a portion of the user's ear is within the detection range of the user interface. As shown in FIG. 4b, after reading the incoming call indication and deciding to accept the call, the user moves the phone device (401) to his ear (491). In this case, he does not interact with the answer or reject call user interface elements (412, 413).

When the phone device is placed close to the users ear (as shown in FIG. 4c), the capacitive touch screen user interface is configured to determine a three dimensional image of the ear (491) (as shown in FIG. 4d). In this case only a lower portion of the user's ear is within the detection range of the capacitive touch screen user interface. In this case, the apparatus/device is configured to model the approaching object by using a net which is deformed by the object being within the detection range of the sensors (not shown). That is, when the sensor, which may be a capacitive sensor, detects an object (e.g. a stylus) approaching, the net is fit to match the data received from the sensor. This creates a three dimensional (3D) image (e.g. a topography or contour map) in which there may be features of possibly different heights and shapes. Other example embodiments may be configured to determine the shape data using various known non-contact technologies, including capacitive technologies.

This three dimensional image received shape data (492) is compared with a predefined three dimensional image ear shape data of an ear (493) (as shown in FIG. 4e). If at least a portion of the received shape data (492) is sufficiently similar to at least a portion of the predefined ear shape data (493), the function of accepting the call is enabled (as shown in FIG. 4f). It will be appreciated that some embodiments may take the size of the object within the detection range of the user interface, whilst other embodiments may not. That is, some embodiments may require that the form and the size of the object represented by the received shape data is consistent with the predefined ear shape data, whereas other embodiments may require that only the form of the of the object represented by the received shape data is consistent with the predefined ear shape data.

It will be appreciated that in other contexts, the particular function which is enabled may be different. For example, if a call was ongoing, and the telephone was in a speaker mode, the apparatus/device may, based on a comparison between received shape data and the predefined ear data, activate a handset mode. Or, for example, if a person was reading textual content (e.g. from a received text message, received email, webpage or e-book) before the apparatus detected an ear the apparatus/device may be configured to perform text-to-speech synthesis on the textual content and read the textual content aloud on detection of the ear.

Likewise, how a function is disabled in response to no longer detecting an ear may be different and/or depend on the context. For example, once the ear is no longer detected, the device/apparatus may hang up or terminate the call or change the mode of the phone to a loudspeaker mode (e.g. in the situation where a user wishes the call to continue but wishes to access content from the device display).

That is, the embodiment is configured to detect the “on ear” situation by using a sensor detecting the shape, profile or 3D topology of the approaching ear and/or head, and based on that detection to enable one or more functions. The functions may be, for example, answering an incoming call when the device is lifted to the ear, or triggering speech synthesis for reading out a recently received text message, calendar alert, email etc., or playing back a voice mail message, or triggering speech recognition to enable the user to place a call or to perform some other speech operated feature.

By using a capacitive sensor, the ear and/or head shape may form part of the predefined ear shape data. That is, depending on the technology, it may be advantageous to recognize the ear alone or recognize the ear and the head around it. For example, a capacitive sensor may be capable of determining whether there is a head shape near a detected ear shaped object. This may, for example, help to distinguish an ear from a case where e.g. a clenched first is placed on the sensor (which may be considered to be similar in shape to an ear).

Advantages of using a capacitive sensor may include that, as hair is not conductive, hair may not be detected by the sensor which may help prevent the presence of hair affecting the comparison between the predefined ear shape data and the received shape data.

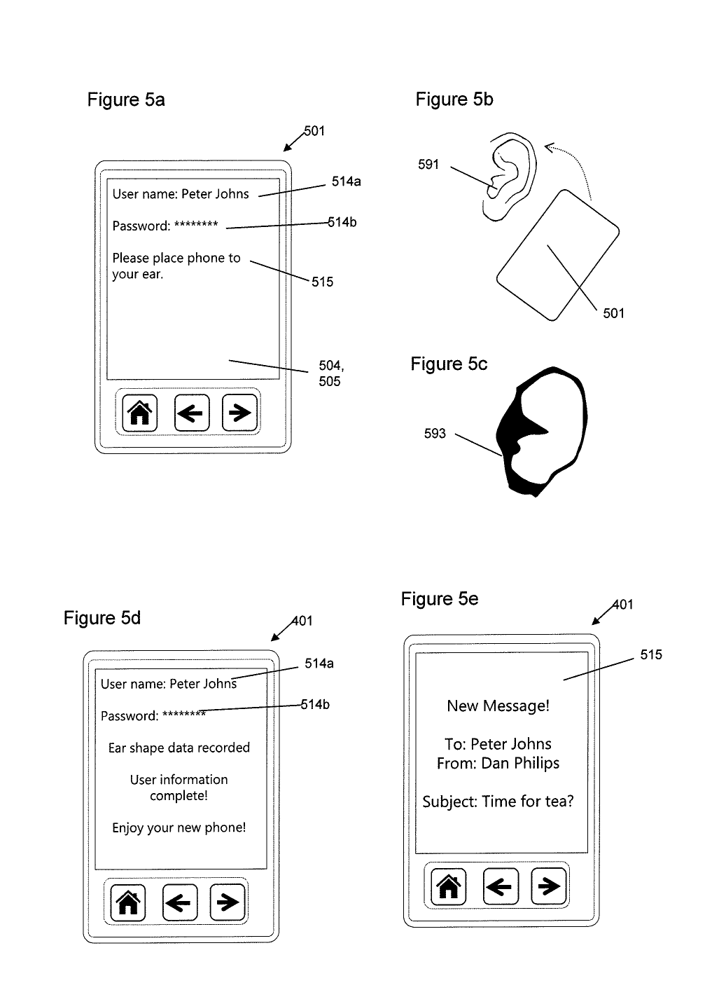

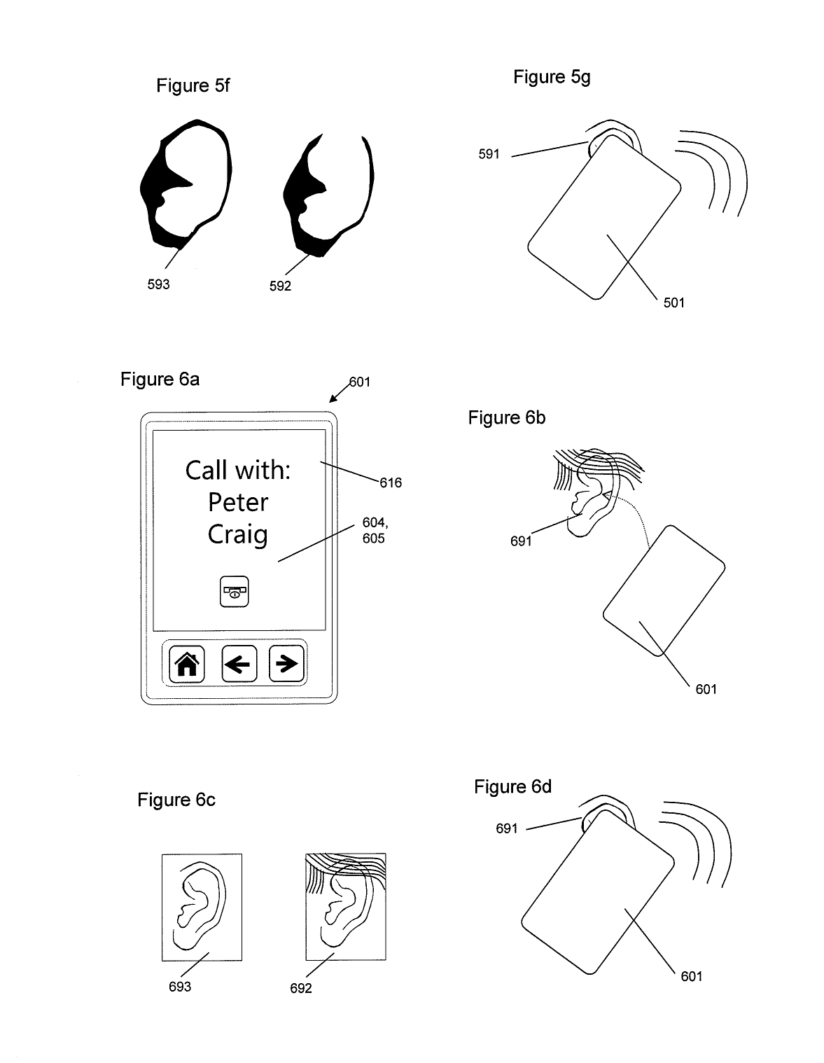

FIGS. 5a-5g depicts an further example embodiment comprising a portable electronic communications device (501), e.g. such as a mobile phone, with a user interface comprising a touch-screen user interface (505, 504), a memory (not shown), a processor (not shown) and an antenna (not shown) for transmitting and/or receiving data (e.g. emails, textual messages, phone calls, information corresponding to web pages).

In this case, the apparatus is configured to: enable selection of a particular function of an electronic device based on a comparison between received shape data corresponding to at least one object within a detection range of a user interface of the electronic device and predefined ear shape data. In this case, if the comparison indicates that the received shape data is consistent with the predefined ear shape data associated with a particular user (thereby indicating that a particular user's ear is within the detection range of the user interface) the apparatus is configured to enable a particular function of the electronic device. That is, the received shape data may be considered to provide authentication information, the authentication information configured to enable the device to authenticate a particular user such that the particular user is allowed to access particular functions which are specific to the particular user. Unlike the previous embodiment which used three dimensional shape data, this embodiment is configured to use two dimensional shape data corresponding to the portions of an object touching the surface of the touch screen user interface.

In the situation depicted in FIG. 5a, the user is using the device for the first time. When the device is being used for the first time, the apparatus/device is configured to enable the predefined ear shape data for that user to be recorded. In this case, the user has established a user name (514a) and password (514b). The device then prompts (515) the user to place the phone to his ear. When the user interface of the phone electronic device (501) is placed to the ear (591) (FIG. 5b), the apparatus is configured to record where the ear touches the surface of the touch screen (or more generally is within the detection range of the touch screen). The recorded two-dimensional ear print (593) is shown in FIG. 5c. This two dimensional ear print is recorded as the predefined ear shape data associated with the user name of the particular user.

When the device has completed recording the predefined ear shape data for the particular user, the screen informs the user that the information required for the user is complete. This is shown in FIG. 5d.

It will be appreciated that other example embodiment may not be configured to have a special training session in which the predefined ear shape data is recorded. For example, the apparatus may be configured such that when a user first receives a telephone call and answers it in a conventional manner (e.g. by pressing an accept call user interface element), and puts the phone to their ear, the apparatus is configured to store the received shape data of the ear object as the predefined ear shape object.

Later a message for Peter Johns is received by the electronic device. In response to receiving the message, the device is configured to indicate: that a message has been received; who sent the message; the intended recipient; and the subject line of the message. In this case, the user could elect to open the message by selecting the message notification in order to read the message which would be displayed on the screen.

In this case, however, the user wishes to hear the message read aloud to him. He therefore places the telephone to his ear. In response to the apparatus receiving shape data, the apparatus is configured to compare the received shape data with the predefined ear shape data provided by the user when the user first used the phone. The comparison is shown in FIG. 5f. In FIG. 5f, the predefined ear shape data is shown on the left, and the received shape data is shown on the right. The received shape data on the right indicates that the user is exerting more pressure with the user interface of the electronic device towards the bottom of the ear and less pressure towards the top of the ear than was the case when the predefined ear shape data was recorded. Nevertheless, based on the size of the ear and the shape of certain features of the ear (which may be within a certain predetermined range), the apparatus is configured to unambiguously identify the particular user.

In response to identifying the particular user, the apparatus is configured to enable the particular function of performing text-to-speech synthesis of the textual content in the body of the received text message and read it aloud to the user (FIG. 5g).

It will be appreciated that if a different user had put the phone electronic device (501) to his ear, the device may not have enabled the text-to-speech synthesis of the message as the received shape data would not have matched the predefined ear shape data corresponding to the recipient of the textual message.

It will be appreciated that other example embodiments may be configured to recognise a member of a particular category of user. For example, the apparatus/device may be configured to activate a particular adult function when the received shape data is consistent with an ear being above a predefined threshold size. In this way, for example, the particular function of initiating a phone call would be prevented for a child (with a small ear) but enabled for an adult (with a large ear).

FIGS. 6a-6d depicts an further example embodiment comprising a portable electronic communications device (601), e.g. such as a mobile phone, with a user interface comprising a touch-screen user interface (605, 604), a memory (not shown), a processor (not shown) and an antenna (not shown) for transmitting and/or receiving data (e.g. emails, textual messages, phone calls, information corresponding to web pages).

In this case, the apparatus is configured to: enable selection of a particular function of an electronic device based on a comparison between received shape data corresponding to at least one object within a detection range of a user interface of the electronic device and predefined ear shape data. In this case, if the comparison indicates that the received shape data is consistent with the predefined ear shape data (thereby indicating that an ear is within the detection range of the user interface), the apparatus is configured to enable the function changing the mode of the device to a handset mode. Unlike the previous example, this embodiment is configured to also base the selection of the particular function on the motion of the device.

In the situation depicted in FIG. 6a, the user is using the device to make a conference call to Peter and Craig. So that the user doesn't need to hold the device he has put the phone electronic device into a speakerphone mode. This increases the volume of the speaker so that it can be heard even when the phone is not against the user's ear. When a conference call is ongoing, the screen is configured to provide a conference call indication (616). In this case, the conference call indication provides textual information including the names of the person taking part in the call.

In this case, the user's colleague enters the room and so the user wishes to change the mode of the device from a speaker mode to a handset mode (e.g. so as not to disturb his colleague and to have privacy in the call). In the handset mode, the speaker volume is decreased so that the incoming audio can only be heard if the phone electronic device is placed to the user's ear. It will be appreciated that the sensitivity of the microphone may also be lowered so the volume of the user's voice is not too loud when sent to the other participants in the call.

In this case, the user moves the electronic device (601) to his ear from a position where the user is looking at the screen, to a position where the top of the phone is against his ear and the bottom of the phone is towards his mouth. This motion is recorded as motion data using accelerometers (not shown) within the electronic device (601), and compared with predefined gesture data. In this case, the motion data comprises velocity data. It will be appreciated that the motion data may be recorded using a combination of one or more of an accelerometer, a gyroscope, a proximity detector and imaging techniques.

When the phone electronic device (601) is placed close to the users ear (691) (as shown in FIG. 6b), the touch screen user interface is configured to record a two dimensional image of the ear (692) (as shown in FIG. 6c) (e.g. using a camera). It will be appreciated that other example embodiments may be configured to generate thermal image shape data (or “heatmap”) of the at least one object. It will be appreciated that when using a camera, the electronic device may be configured to illuminate the object (e.g. with an IR LED) to ensure consistent imaging.

This two dimensional image received shape data (692) is compared with a predefined two dimensional image ear shape data (693) (as shown in FIG. 6c). The predefined ear data (693) is shown in the left, and the received shape data (692) is shown on the right. It can be seen that a portion of the ear is covered by hair in the received shape data image (692). However, the apparatus will return a positive comparison if a sufficient portion of the received shape data corresponds to the predefined shape data. It will be appreciated that in some embodiments, data representing hair may form part of the predefined ear shape data.

If the motion data matching the predefined gesture data is followed by receiving shape data matching the predefined shape data, the function of entering a handset mode is enabled (as shown in FIG. 6d). Using the gesture comparison in combination with the shape comparison may reduce the likelihood of a false-positive comparison. That is, enabling the particular function (e.g. turning on a handset mode) is only taken when a shape resembling an ear is detected, and this has been preceded by a set of movements that match accurately enough to the phone electronic device being lifted to the ear.

Although, in this case, an accelerometer is used to detect motion data, it will be appreciated that the camera itself may be configured to detect motion data. For example, the camera may be configured to take a series of images and track the movement of features across the series of images to infer the motion of the electronic device.

In this case, if the user wishes to return the phone electronic device to the speaker mode (e.g. if his collegue leaves the room), the apparatus/device is configured to enable termination of the particular function of an electronic device (which in this case it enabling the handset mode of the electronic device) when the received data within the detection range of a user interface of the electronic device is inconsistent with the predefined ear shape data. That is, when the phone electronic device is no longer placed next to the ear, the particular function (handset mode in this case) may be terminated and, in this case, the speaker phone mode may be reactivated.

Advantages of the enabling functionality according to received shape data may include that the user interface can respond differently to different users, or different categories of users. This may mean that the user interface may not require additional user interface elements to implement user preferences. In addition, performing functions associated with the ear based on the detection of an ear may provide a more intuitive user experience. Furthermore, enabling function using object detection may reduce the need for specific user interface elements relating to that function to be present on-screen (e.g. icons, menu items). This may allow a more intuitive and less cluttered user interface.

Advantages of detecting the ear itself (e.g. rather than using motion comparisons alone) may include that that enabling the particular functions may be more robust and/or consistent in different usage contexts where the motion of a user putting an electronic device to their ear is different to normal or inconsistent (such as when lying on bed or e.g. jogging).

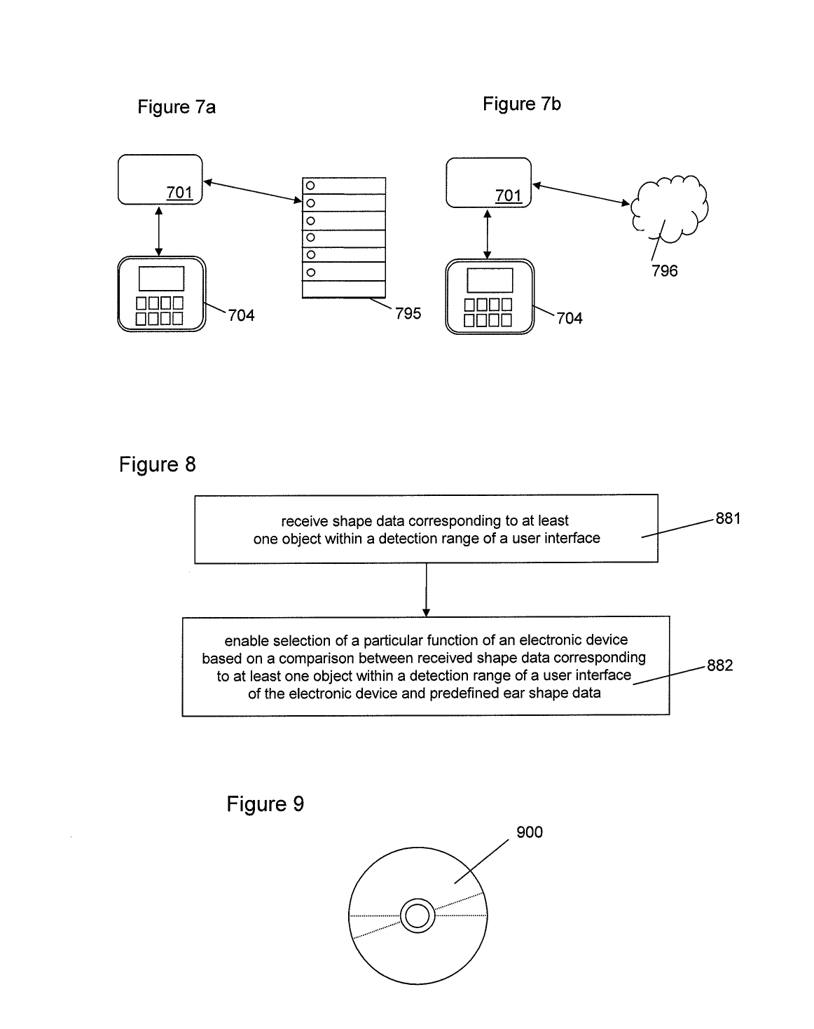

FIG. 7a shows that an example embodiment of an apparatus in communication with a remote server. FIG. 7b shows that an example embodiment of an apparatus in communication with a “cloud” for cloud computing. In FIGS. 7a and 7b, apparatus (701) (which may be apparatus (101), (201) or (301)) is in communication with a display (704). Of course, the apparatus (701) and display (704) may form part of the same apparatus/device, although they may be separate as shown in the figures. The apparatus (701) is also in communication with a remote computing element. Such communication may be via a communications unit, for example. FIG. 7a shows the remote computing element to be a remote server (795), with which the apparatus may be in wired or wireless communication (e.g. via the internet, Bluetooth, a USB connection, or any other suitable connection as known to one skilled in the art). In FIG. 7b, the apparatus (701) is in communication with a remote cloud (796) (which may, for example, by the Internet, or a system of remote computers configured for cloud computing). Some or all of the user applications and/or user content may be stored at the apparatus (101), (201), (301), (701). The functionality of shape data comparison and the provision of a particular function may be provided at the respective remote computing element (795), (796). The apparatus (701) may actually form part of the remote sever (795) or remote cloud (796). In such embodiments, the enablement of the shape data comparison and the provision of the particular function may be conducted by the server or in conjunction with use of the server/cloud.

FIG. 8 illustrates the process flow according to an example embodiment of the present disclosure. The process comprises receiving (881) shape data corresponding to at least one object within a detection range of a user interface; and enabling (882) selection of a particular function of an electronic device based on a comparison between received the shape data corresponding to at least one object within a detection range of a user interface of the electronic device and predefined ear shape data. The respective functionality (881) and (882) may be performed by the same apparatus or different apparatus.

FIG. 9 illustrates schematically a computer/processor readable medium (900) providing a program according to an embodiment. In this example, the computer/processor readable medium is a disc such as a Digital Versatile Disc (DVD) or a compact disc (CD). In other embodiments, the computer readable medium may be any medium that has been programmed in such a way as to carry out the functionality herein described. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc.), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to example embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
enable selection of a particular function of an electronic device based on a comparison between received shape data corresponding to at least one object within a detection range of a user interface of the electronic device and predefined ear shape data.

2. The apparatus of claim 1, wherein the received shape data comprises one or more of:
an image of the at least one object;
a 3D topology of the at least one object;
a tomogram of the at least one object; and
a 2D print of the object.

3. The apparatus of claim 1 wherein the particular function comprises:
enabling a particular device operating mode of a plurality of device operating modes associated with the electronic device; and

4. The apparatus of claim 1 wherein the particular function comprises:
enabling a particular application operating mode of a plurality of application operating modes associated with the electronic device.

5. The apparatus of claim 1 wherein the particular function comprises one or more of:
answering an incoming call;
activating speech synthesis of textual content (e.g. received text message, calendar alert, email); and
activating a handset mode.

6. The apparatus of claim 1, wherein the selection of the particular function is also based on:
a comparison between received motion data corresponding to the motion of the electronic device and predefined gesture data.

7. The apparatus of claim 1, wherein the motion data comprises data relating to one or more of:
velocity of a said electronic device;
distance travelled by said electronic device;
the trajectory of a said electronic device;
speed of a said electronic device; and
acceleration of a said electronic device.

8. The apparatus of claim 1, wherein the selection of the particular function is also based on:
a comparison between received colour data corresponding to the at least one object within the detection range of the user interface of the electronic device and predefined colour data.

9. The apparatus of claim 1, wherein the received shape data is detected by at least one of:
a capacitive sensor;
a touch sensor;
a camera;
a temperature sensor; and
an infrared sensor.

10. The apparatus of claim 1, wherein the predefined ear data is associated with a particular user, the enabled function corresponding to the particular user.

11. The apparatus of claim 1, wherein the received shape data is configured to provide authentication information, the authentication information configured to enable the device to authenticate a particular user such that the particular user is allowed to access particular functions which are specific to the particular user.

12. The apparatus of claim 1, wherein the predefined ear data is recorded by the apparatus when a user holds their ear within the detection range of a user interface of the electronic device.

13. The apparatus of claim 1, wherein the apparatus is configured to:
enable termination of the particular function of an electronic device when the received data within the detection range of a user interface of the electronic device is inconsistent with the predefined ear shape data.

14. The apparatus of claim 1, wherein the user interface comprises a combination of one or more of a speaker, a microphone, a handset, a headset, a touchpad, and a touch-screen.

15. The apparatus of claim 1, wherein the apparatus or electronic device is a portable electronic device, a laptop computer, a desktop computer, a mobile phone, a tablet computer, a Smartphone, a monitor, a personal digital assistant or a digital camera, or a module for the same.

16. A method comprising:
enabling selection of a particular function of an electronic device based on a comparison between received shape data corresponding to at least one object within a detection range of a user interface of the electronic device and predefined ear shape data.

17. A non-transitory medium comprising computer program code, the computer program comprising code configured to:
enable selection of a particular function of an electronic device based on a comparison between received shape data corresponding to at least one object within a detection range of a user interface of the electronic device and predefined ear shape data.
